(19) United States
(12) Patent Application Publication
(10) Pub. No.: US 2018/0104147 A1
(43) Pub. Date: Apr. 19, 2018

(54) DRY STERILIZABLE BAG AND CLAMP FOR STORING LIQUID AND FROZEN MEDIA AND DISPENSING

(71) Applicant: ENTEGRIS, INC., Billerica, MA (US)

(72) Inventors: Donald D. WARE, Woodbury, MN (US); Amy KOLAND, Eden Prairie, MN (US); Brenna BROSCH, Chanhassen, MN (US); John A. LEYS, Chaska, MN (US); Michael W. JOHNSON, St. Louis Park, Hennepin, MN (US); Michael J. SCHLEICHER, Victoria, MN (US)

(21) Appl. No.: 15/564,864

(22) PCT Filed: Apr. 8, 2016
(86) PCT No.: PCT/US2016/026658

§ 371 Date: Oct. 6, 2017

Related U.S. Application Data
(60) Provisional application No. 62/145,905, filed on Apr. 10, 2015.
(60) Provisional application No. 62/248,680, filed on Oct. 30, 2015.

(51) Int. Cl. A61J 1/14; A61J 1/10

(52) U.S. Cl. CPC A61J 1/1475; A61J 1/1468; A61J 1/1462; A61J 1/1481; A61J 1/1487; A61J 1/10

(57) ABSTRACT

A single-use bag (32) and dispensing system (30) for storage of liquid or frozen media and for dispensing the media are disclosed. A single-use bag (32) is composed of materials that can withstand the temperatures required for dry heat sterilization and, further, includes specialized clamps (40, 140) that accommodate the materials and construction techniques necessary for constructing the single-use bag (32) for restriction and isolation of flow from the single-use bag (32). The single-use bag (32) includes an inner film (76) defining a bag interior (52) and an outer film (78) overlying the inner film (76), the inner film (76) and the outer film (78) being heat bonded together, the inner film (76) being composed of perfluoroalkoxy alkane (PFA) and the outer film (78) being composed of polytetrafluoroethylene (PTFE), the single-use bag (32) defining at least one exit port (62) on a bottom edge (48) thereof; and at least one closeable exit passage (34) depending from the bottom edge (48) of the single-use bag (32), each of the at least one exit passage (34) being coupled to a respective one of the at least one exit port (62), the at least one exit passage (34) being in fluid communication with the bag interior (52).

### RELATED APPLICATIONS

This application claims the benefit of U.S. Provisional Application No. 62/248,680, filed on Oct. 30, 2015, which is related to U.S. Provisional Application No. 62/145905, filed on Apr. 10, 2015, the contents of which are incorporated herein by reference in their entirety for all purposes.

### BACKGROUND OF THE INVENTION

Conventional single-use bags, such as drip bags, often comprise polyethylene and are often sterilized using a gamma radiation treatment. Recently, preference has shifted away from gamma radiation treatment in favor of dry heat sterilization. However, polyethylene often cannot withstand the heat required to achieve the necessary sterilization.

A single-use bag that can withstand the temperatures of dry heat sterilization while not compromising flow control would be welcomed.

### SUMMARY OF THE INVENTION

Various embodiments of the present disclosure provide a single-use bag composed of materials that can withstand the temperatures required for dry heat sterilization and further includes specialized clamps that accommodate the materials and construction techniques necessary for constructing the single-use bag for restriction and isolation of flow from the single-use bag. Single-use bags of the present invention are constructed to be capable of holding large volumes of liquid and frozen media while the bag is being suspended. Single-use bags are intended to be used once and then disposed.

A storage and dispensing system capable of storing a liquid or frozen medium and dispensing the medium is provided. The system includes a single-use bag, the bag including an inner film defining a bag interior and an outer film overlying the inner film. The inner film and the outer film are heat bonded together. The inner film is composed of perfluoroalkoxy alkane (PFA), and the outer film is composed of polytetrafluoroethylene (PTFE). The single-use bag defines at least one exit port on a bottom edge thereof. The storage and dispensing system also includes at least one closeable exit passage depending from the bottom edge of the single-use bag. The exit passage(s) are coupled to respective exit port(s) and are in fluid communication with the bag interior. The exit passage(s) can be unitary with the single-use bag. The inner film and the outer film can be laminated together.

The system can include a clamp having opposed jaws, each of the opposed jaws including a compliant member disposed on a rigid sub structure. The compliant members of the opposed jaws are capable of engaging each other along a line of contact when the opposed jaws are in a closed position. The clamp is configured to engage one of the exit passage(s) for restricting flow through the exit passage. The opposed jaws can be pivotally connected. The clamp can include a ratchet and pawl for locking the opposed jaws in a fixed relationship when the clamp is occupied by the exit passage. The compliant members can have a hardness in a range of Shore A 10 to Shore A 60, inclusive, and can have a thickness in a direction of closing the opposed jaws in a range of about 1 mm to about 5 mm inclusive. The compliant members can each include a partial sleeve configured to fit over a respective one of the rigid sub structures. The compliant members can be overmolded onto the rigid sub structures.

### BRIEF DESCRIPTION OF THE DRAWINGS

FIG. 1 is an elevational view of a dispensing system in an embodiment of the disclosure.

FIG. 2 is a side perspective view of a clamp in an embodiment of the disclosure.

FIGS. 3 and 4 are perspective and side views, respectively, of an alternative clamp in an embodiment of the disclosure.

FIGS. 5 and 6 are schematic views of a clamp in operation in an embodiment of the disclosure.

FIG. 5A is an enlarged, partial sectional view of an exit passage of FIG. 5.

FIG. 7 is an elevational view of a single-use bag dispensing system in an embodiment of the disclosure.

FIGS. 8 and 9 are fittings for use in the embodiment of FIG. 7.

FIGS. 10 and 11 are cross-section views of embodiments of the bag of the dispensing system of FIG. 1.

FIG. 12 is a cross-section view of an exit passage of a single-use bag in accordance with embodiments of the disclosure.

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

### DETAILED DESCRIPTION OF THE INVENTION

While this invention will be particularly shown and described with references to example embodiments thereof, it will be understood by those skilled in the art that various changes in form and details may be made therein without departing from the scope of the invention encompassed by the appended claims.

While various compositions and methods are described, it is to be understood that this invention is not limited to the particular molecules, compositions, designs, methodologies or protocols described, as these may vary. It is also to be understood that the terminology used in the description is for the purpose of describing the particular versions or versions only, and is not intended to limit the scope of the present invention which will be limited only by the appended claims.

It must also be noted that as used herein and in the appended claims, the singular forms “a”, “an”, and “the” include plural reference unless the context clearly dictates otherwise. Thus, for example, reference to a “film” is a reference to one or more films and equivalents thereof known to those skilled in the art, and so forth. Unless defined otherwise, all technical and scientific terms used herein have the same meanings as commonly understood by one of ordinary skill in the art. Methods and materials similar or equivalent to those described herein can be used in the practice or testing of versions of the present invention. All publications mentioned herein are incorporated by reference in their entirety. Nothing herein is to be construed as an admission that the invention is not entitled to antedate such disclosure by virtue of prior invention. “Optional” or “optionally” means that the subsequently described event or circumstance may or may not occur, and that the description includes instances where the event occurs and instances where it does not. All numeric values herein can be modified by the term “about,” whether or not explicitly indicated. The term “about” generally refers to a range of numbers that one of skill in the art would consider equivalent to the recited value (i.e., having the same function or result). In some versions the term “about” refers to ±10% of the stated value, in other versions the term “about” refers to ±2% of the stated value. While compositions and methods are described in terms of “comprising” various components or steps (interpreted as meaning “including, but not limited to”), the compositions and methods can also “consist essentially of” or “consist of” the various components and steps, such terminology should be interpreted as defining essentially closed-member groups.

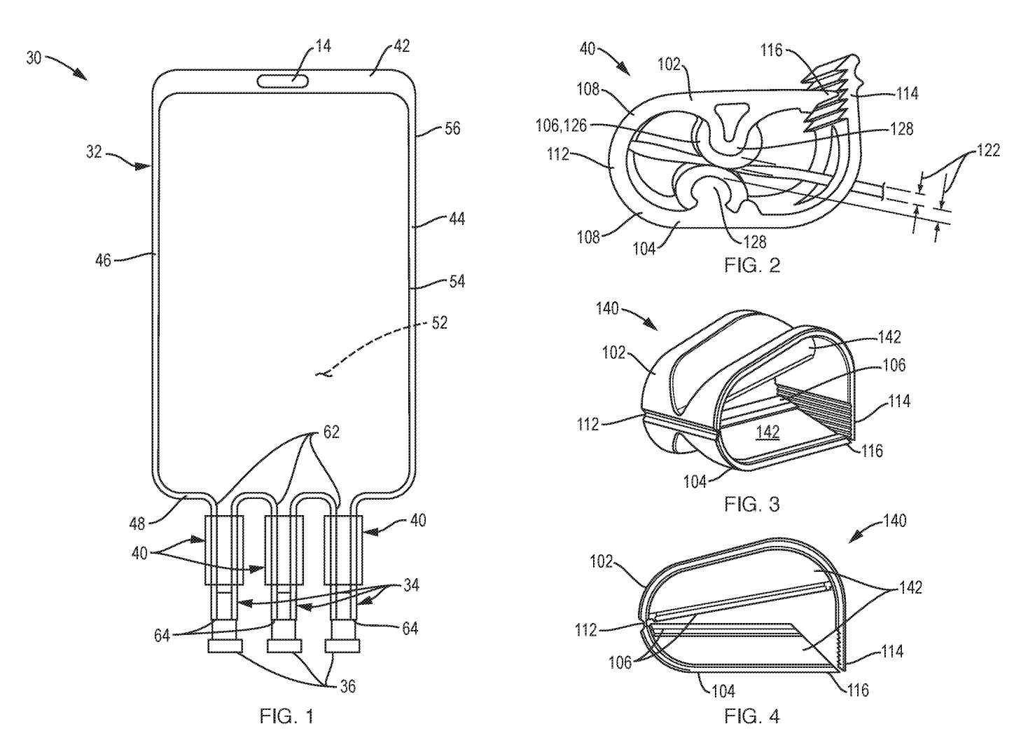

Referring to FIG. 1, a dispensing system 30 for single-use bags is depicted in an embodiment of the disclosure. The dispensing system 30 includes a single-use bag 32 including at least one exit passage 34, each of the exit passages 34 being fitted with an external clamp 40 for selective sealing and control of flow from a liquid medium contained within the single-use bag 32. In the depicted embodiment, the single-use bag 32 is characterized has having a top edge 42, two side edges 44 and 46, and a bottom edge 48, the exit passages 34 depending from the bottom edge 48. In some embodiments, the dispensing system 30 includes fittings 36 coupled to the distal ends of the exit passages 34.

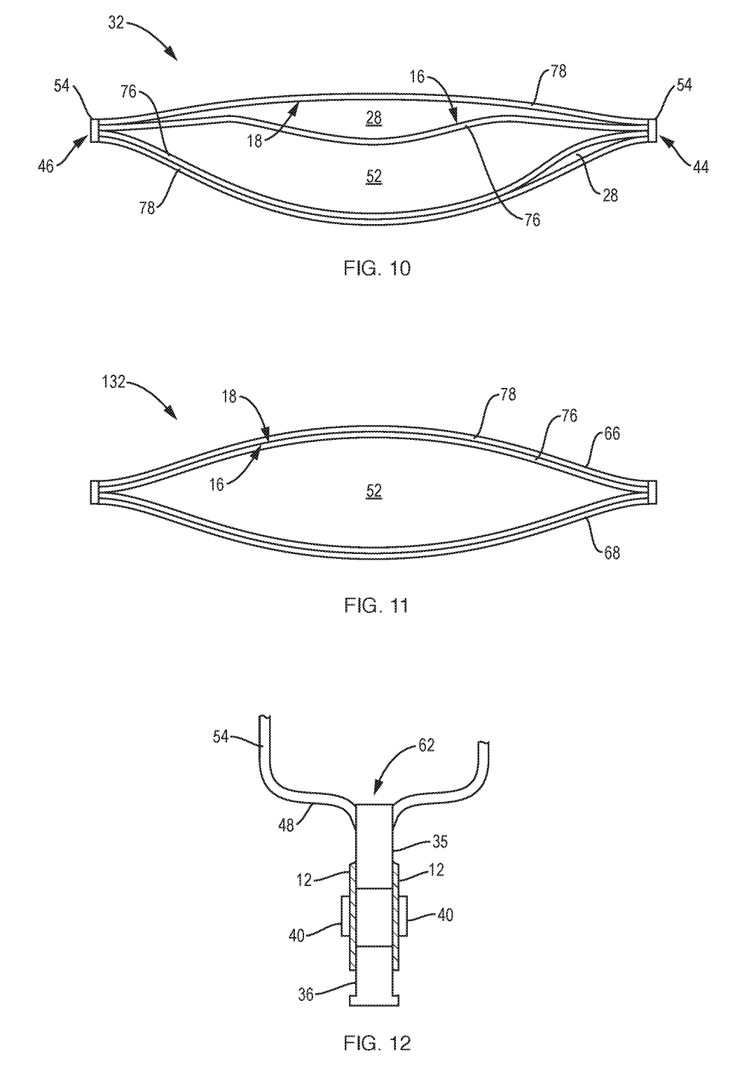

In various embodiments, the single-use bag 32 includes an inner film defining a bag interior 52 and an outer film overlying said inner film, the inner film and the outer film being heat bonded (e.g., fused or welded) together along a seam 54 proximate an outer perimeter 56 of the single-use bag 32. The inner film and the outer film of the single-use bag 32 can remain distinct sheets of material, that is, they are bonded together only along seam 54. A cross-section view of single-use bag 32 with distinct inner and outer films is shown in FIG. 10. An outer surface 16 of the inner film 76 may or may not be in direct and continuous contact with an inner surface 18 of the outer film 78. As such, gaps 28, may form between the inner films 76 and outer films 78.

Alternatively, an inner film and an outer film can be laminated together (for example, bonded or fixed together over the entire contact area of the films) such that they form a single sheet of material having two layers, as shown in FIG. 11. A cross-section view of a single-use bag 132 formed from single sheets of material 66, 68, each sheet 66, 68 having at least two layers 76, 78 of film laminated together such that the upper surface 16 of the inner film 76 is in direct contact with the lower surface 18 of the outer film 78 and more particularly, such that the upper surface 16 of the inner film 76 is in direct and continuous contact with the lower surface 18 of the second film 78. In further embodiments, additional layers of film may be included in sheets 66, 68 (e.g., one or more middle layers of film between inner film 76 and outer film 78 can be included). Obviously, in such an embodiment, upper surface 16 would no longer be in direct and continuous contact with lower surface 18. Single-use bag 132 having laminated films prevents gaps 28 (as shown in FIG. 10) from forming. Gaps 28 may be undesirable as they may hinder clamping at exit passages 34 and prevent liquid-tight seals.

The single-use bag 32 defines at least one exit port 62 formed at the bottom edge 48—a corresponding or respective exit port 62 for each of the at least one exit passage 34. In the embodiment depicted in FIG. 1, the exit passages 34 are unitary with the single-use bag 32, that is, exit passages 34 are cut or formed from the same, continuous material that forms single-use bag 32. In various embodiments, the single-use bag 32 and unitary exit passages 34 are formed of two planar sheets, each sheet including the inner and outer films, which may or may not be laminated together as described herein according to the various embodiments.

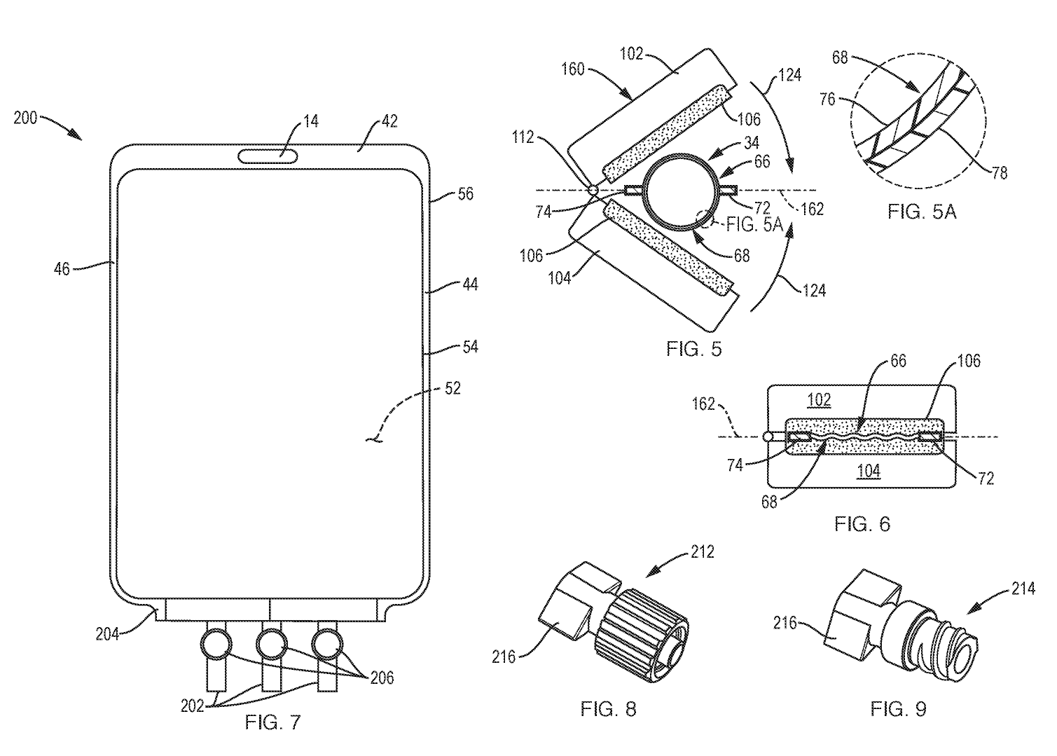

In assembly, the sheets are arranged so that the inner layers are facing toward each other and cut to the shape outlined in FIG. 1. The edges 42, 44, 46 and 48 are heat bonded to form the seam 54. For the depicted embodiment, the seam 54 follows the contour of the exit passages 34, except the seam 54 does not seal distal ends 64 of the exit passages 34. Accordingly, each exit passage 34 is defined by the two sheets 66 and 68, with opposing edges 72 and 74 joined at the seam 54 (FIG. 5). Again, each sheet 66 and 68 includes inner and outer films 76 and 78 (FIG. 5A).

Optionally, instead of two sheets, the single-use bag 32 can be assembled from a single sheet of material folded onto itself (for example, along the upper edge 42) so that an inner layer of the material faces itself. The single sheet of material can then be cut and sealed along the remaining edges (for example, along edges 44, 46, and 48).

In one embodiment, each sheet of material 66, 68 can have a thickness of about 2.5 mil (63.5 μm) to about 30 mil (762 μm), or of about 6 mil (152.4 μm) to about 15 mil (381 μm). As described above, each sheet of material can include at least two layers, including an inner layer (formed from a film of a first type) and an outer layer (formed from a film of a second type). The inner layer may alternatively be referred to as the wetted surface, and the outer layer may alternatively be referred to as the non-wetted surface.

Both the inner and outer layers can be composed of fluoropolymers. In a particular embodiment, the inner layer of each sheet is composed of perfluoroalkoxy alkane (PFA) and the outer layer of each sheet is composed of polytetrafluoroethylene (PTFE). The inner layer can have a thickness of about 0.5 mil (12.7 μm) to about 15 mil (381 μm), or of about 1 mil (25.4 μm) to about 5 mil (127 μm). The outer layer can have a thickness of about 2 mil (50.8 μm) to about 15 mil (381 μm), or of about 5 mil (127 μm) to about 10 mil (254

In further embodiments, the outer layer of each sheet can be composed of PTFE hybrid materials, including modified PTFE, such as PTFE modified with perfluoropropyl vinyl ether (PPVE). Modified PTFE provides improved fatigue resistance over standard PTFE and is described further in U.S. Pat. No. 7,407,708, the entire teachings of which are incorporated herein by reference. For example, modified PTFE can contain specific amounts of perfluoro alkyl residue on the main polymer chain that is useful in acting as a barrier against chemicals and can have reduced crystallinity, reducing the chance of fibrillation of the resin after several cycles of bending. The PTFE can be skived PTFE or extrudable PTFE (e.g., Moldflon™, ElringKlinger, Germany).

Functionally, the PFA and PTFE materials can withstand the temperatures of dry heat sanitation without adverse effects, which can range from 160° C. to 270° C. for some applications. Typically, 160° C. is the minimum temperature that is applied in dry heat sterilization, with a standard temperature range of about 160° C. to 170° C. However, it is often desirable to reach temperature ranges closer to depyrogenation, which may be up to 270° C. Higher temperatures can also reduce cycle time.

PFA is preferred for an inner layer as it is a flexible polymer with a low coefficient of friction and is inert to a large variety of chemicals and solvents. As such, an inner layer composed of PFA provides a wettable surface that will not react with solutions contained in the bag. Additionally, as films are cleaned prior to their assembly into single-use bags, PFA provides an easily cleanable material for use as an inner layer of single-use bags.

Skived PTFE is also inert to most chemicals and solvents; however, as compared to PFA, skived PTFE has a rough surface that lends itself to particulation and is more difficult to clean than PFA. Particulation is undesirable as it may contaminate the solution contained in the bag. PTFE is preferred for an outer layer as it provides strength and structure to the bag and has greater stress-cracking resistance than PFA. Stress-cracking, which can occur when the film materials are exposed to excessive tensile stress, can cause leaks in the single-use bag and is a concern during sterilization and dispensing processes, particularly for bags holding larger volumes of liquid. A bag formed from a sheet of material having an inner layer of PFA and an outer layer of PTFE is able to provide a secure, non-reactive vessel for a solution undergoing a dry heat sterilization process. An additional benefit of assembling a bag with an inner layer of PFA and an outer layer of PTFE is that PFA is capable of sealing at a lower temperature than PTFE. PFA has a melting point of about 305° C., and PTFE has a melting point of about 327° C. As such, during assembly of single-use bags, both materials need not be melted in order to seal sheets of material together (e.g., at seam 54).

In a further embodiment, an outer and/or inner layer of the bag is composed of extrudable PTFE, which has a smoother surface than skived PTFE. Extrudable PTFE can offer improved resistance to particulation due to its smoother surface and can serve as an inner layer of a bag.

To create a single sheet of material formed from PFA and PTFE, layers of PFA and PTFE undergo a lamination process. Due to the lower melting point of PFA, films of PFA can be heat bonded to films of PTFE over their entire surface area, forming a single composite material.

In a further embodiment, a skived PTFE film undergoes the lamination process described above and serves as both the inner and outer layers of a sheet of material from which a single-use bag may be assembled. After undergoing the lamination process, the surface texture of skived PTFE is transformed to a smoother surface, reducing the likelihood of particulation.

Single-use bags can have volumetric capacities of about 500 mL to about 20 L. For example, a single-use bag can have a capacity of 50 0 mL, 1 L, 2 L, 3 L, 5 L, 10 L, 15 L or 20 L. During dry-heat sterilization and/or dispensing, single-use bags 32 will typically be suspended. Seam 54 along edge 42 can include opening 14 through which a hook or other fixture can be threaded to suspend the bag 32 during the sterilization process. Single-use bags 32 are capable of withstanding the weight of volumes of liquid up to about 20 L while the bags are suspended and undergoing sterilization/dispensing processes.

Returning to FIG. 1, the fitting(s) 36 enables ready and reliable connection with various attachment parts and objects, such as tube sets, fitters, and syringes. Suitable fittings(s) 36 include, but are not limited to, hose barbs, luer fittings, quick connectors/disconnectors, such as Quikgrip® fittings (Entegris, Billerica, Mass.), and flare-type fittings, such as Flaretek® fittings (Entegris, Billerica, Mass.).

Referring to FIGS. 2 and 5, the clamp 40 is depicted in embodiments of the disclosure. The clamp 40 includes opposed jaws 102 and 104, each of the opposed jaws 102, 104 including a compliant member 106 disposed on a rigid sub structure 108. In one embodiment, the compliant members 106 of said opposed jaws 102 and 104 are capable of engaging each other along a line of contact when said opposed jaws 102 and 104 are in a fully closed position. Each clamp 40 is configured to engage a corresponding one of the at least one exit passage 34 to restrict seal off flow through the exit passage 34. In various embodiments, the opposed jaws 102, 104 are connected at a pivot, pivot zone, or hinge 112. Also, the clamp 40 can include a ratchet 114 and pawl 116 as depicted.

The compliant members 106 are made of a soft material that complies with a contour of an object that is compressed between the opposed jaws 102 and 104. In various embodiments, the compliant members 106 have a hardness in a range of Shore A 10 to Shore A 60 inclusive. (Herein, a range that is said to be “inclusive” includes the endpoints of the stated range.) Each compliant member 106 can be further characterized as having a thickness 122 (FIG. 2) in a direction 124 (FIG. 5) of closing of the opposed jaws 102, 104. In various embodiments, the thickness 122 is in a range of 1 mm to 5 mm inclusive. In one embodiment, each compliant member 106 takes the form of a partial sleeve 126. By “partial” sleeve 126, it is meant that the member 126 does not define a continuous cross section, but instead an open cross-section, such as a C-shape (depicted in FIG. 2), a U-shape, or a V-shape. In the FIG. 2 embodiment, the rigid sub structure 108 defines an arcuate feature 128 over which the partial sleeve 126 is fitted (for example, slid or pressed onto). The partial sleeve 126 can also be bonded to the rigid sub structure 108.

Referring to FIGS. 3 and 4, a clamp 140 is depicted in an embodiment of the disclosure. The clamp 140 includes many of the same components and attributes as the clamp 40, which are identified by same-numbered numerical references. The opposed jaws 102, 104 each define a V-shaped ridge 142. The compliant members 106 are disposed on the V-shaped ridges 142. In one embodiment, the compliant members 106 are cut from a sheet material and bonded to the V-shaped ridges 142 to assume a V-shape in cross-section. In other embodiments, the compliant members 106 are overmolded onto the opposed jaws 102, 104.

Referring to FIGS. 5 and 6, operation of a clamp 160 is schematically represented in an embodiment of the disclosure. The clamp 160, which generically represents either clamp 40 or 140, includes the same fundamental components as the clamps 40 and 140, including opposed jaws 102, 104, compliant members 106, and the pivot 112. The clamp 160 is depicted in progressive engagement with one of the at least one exit passages 34, with the clamp 160 being in an open configuration in FIG. 5 and in a fully closed configuration in FIG. 6. The exit passage 34 is depicted in cross-section normal to the distal end 64 (FIG. 1). The cross-section portrays portions of the two sheets 66 and 68 that define the boundaries of the exit passage 34, as well as the opposing edges 72 and 74. The opposing edges 72 and 74 are depicted as lying substantially on a plane 162.

In operation, the clamp 160 is positioned so that, upon closure, the opposed jaws 102, 104 converge substantially at the plane 162. In this way, the sheets 66 and 68 are brought into planar alignment with the opposing edges 72 and 74. In various embodiments, the clamp 160 can pinch the sheets 66 and 68 together to provide a liquid-tight seal. In various embodiments, the seam 54 that defines the opposing edges 72 and 74 are thicker than the combined thicknesses of the two sheets 66 and 68. The compliant members 106 conform to the topography defined by the opposing edges 72 and 74 and the two sheets 66 and 68 to exert a pressure along the interface of the two sheets 66 and 68, thereby providing the seal. The clamp 160 can also be loosened to allow restricted flow through the exit passage 34. It is also contemplated that a single clamp (not depicted) could be utilized to restrict or isolate flow through more than one exit passage 34.

Referring to FIGS. 7 through 9, a dispensing system 200 is depicted in an embodiment of the disclosure. The dispensing system 200 includes many of the same components and attributes as the dispensing system 30, which are identified with same-numbered numerical references. For the dispensing system 200, at least one fitting 202 depends from a substantially straight bottom edge 204. The fitting(s) 202 can include valves 206 for selective restriction or isolation of flow through the fitting 202. In one embodiment, the fitting(s) 202 include a female luer 212 (FIG. 8) or a male luer 214 (FIG. 9). The fitting(s) 202 can also include a diamond-shaped fitment 216 (commonly referred to as a “boat”), such as depicted in FIGS. 8 and 9.

In assembly, the fitment 216 is inserted between the sheets 66 and 68 along the bottom edge 204, and bonded to the bottom edge 204. The fitting(s) 202 are thus placed in fluid communication with the bag interior 52.

Referring to FIG. 12, an alternative clamping mechanism is applied at exit port 62. Due to the nonstick features of PFA and PTFE, clamping of the sheets of material against each other can be difficult. Additionally, thin sheets can be difficult to clamp because they are not compliant. As shown in FIG. 12, a tubing stub 35 can be fitted at exit port 62 and sealed against seam 54 along bottom edge 48. An annular film 12 has a first end that is sealed to tubing stub 35 and a second end that accommodates fitting 36. Clamp 40 is applied to annular film 12 at the region between tubing stub 35 and fitting 36. Annular film 12 can be made of the same or similar material that forms single-use bag 32, such as a PTFE film with or without an inner layer of PFA film. Annular film 12 can be formed from a sheet of material that is sealed to itself, such as by a fin seal, to create a tube of film having a diameter that is capable of receiving and sealing against tubing stub 35 and fitting 36.

The single-use bags 32 herein have been depicted with three exit passages 34, but can be made shorter and wider to accommodate more exit passages 34 along the bottom edge 48, 204. The configuration of a single-use bag having multiple exit passages will depend upon the volume of media intended to be stored and dispensed from the bag. A person having ordinary skill in the art can determine a suitable width of single-use bags 32 and a suitable number of exit passage(s) 34 based on the teachings in this application.

Each of the additional figures and methods disclosed herein can be used separately, or in conjunction with other features and methods, to provide improved devices and methods for making and using the same. Therefore, combinations of features and methods disclosed herein may not be necessary to practice the disclosure in its broadest sense and are instead disclosed merely to particularly describe representative and preferred embodiments.

Various modifications to the embodiments may be apparent to one of skill in the art upon reading this disclosure. For example, persons of ordinary skill in the relevant art will recognize that the various features described for the different embodiments can be suitably combined, un-combined, and re-combined with other features, alone, or in different combinations. Likewise, the various features described above should all be regarded as example embodiments, rather than limitations to the scope or spirit of the disclosure.

Persons of ordinary skill in the relevant arts will recognize that various embodiments can comprise fewer features than illustrated in any individual embodiment described above. The embodiments described herein are not meant to be an exhaustive presentation of the ways in which the various features may be combined. Accordingly, the embodiments are not mutually exclusive combinations of features; rather, the claims can comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

References to “embodiment(s)”, “disclosure”, “present disclosure”, “embodiment(s) of the disclosure”, “disclosed embodiment(s)”, and the like contained herein refer to the specification (text, including the claims, and figures) of this patent application that are not admitted prior art.

For purposes of interpreting the claims, it is expressly intended that the provisions of 35 U.S.C. 112(f) are not to be invoked unless the specific terms “means for” or “step for” are recited in the respective claim.

While this invention has been particularly shown and described with references to example embodiments thereof, it will be understood by those skilled in the art that various changes in form and details may be made therein without departing from the scope of the invention encompassed by the appended claims.

1. A storage and dispensing system capable of storing a liquid or frozen medium and dispensing the medium, the system comprising:
a single-use bag including an inner film defining a bag interior and an outer film overlying the inner film, the inner film and the outer film being heat bonded together, the inner film being composed of perfluoroalkoxy alkane and the outer film being composed of polytetrafluoroethylene, the single-use bag defining at least one exit port on a bottom edge thereof; and
at least one closeable exit passage depending from the bottom edge of the single-use bag, each of the at least one exit passage being coupled to a respective one of the at least one exit port, the at least one exit passage being in fluid communication with the bag interior.

2. The storage and dispensing system of claim 1, wherein each of the at least one exit passage is unitary with the single-use bag.

3. The storage and dispensing system of claim 1, further comprising a clamp having opposed jaws, each of the opposed jaws including a compliant member disposed on a rigid sub structure, wherein:
the compliant members of the opposed jaws are capable of engaging each other along a line of contact when the opposed jaws are in a closed position; and
the clamp is configured to engage one of the at least one exit passage for restricting flow through the exit passage.

4. The storage and dispensing system of claim 3, wherein the opposed jaws are pivotally connected.

5. The storage and dispensing system of claim 3, wherein the clamp comprises a ratchet and pawl for locking the opposed jaws in a fixed relationship when the clamp is occupied by the exit passage.

6. The storage and dispensing system of claim 3, wherein the compliant members have a hardness in a range of Shore A 10 to Shore A 60.

7. The storage and dispensing system of claim 3, wherein the compliant members have a thickness in a direction of closing the opposed jaws, the thickness being in a range of about 1 mm to about 5 mm.

8. The storage and dispensing system of claim 6, wherein the compliant members each comprise a partial sleeve configured to fit over a respective one of the rigid sub structures.

9. The storage and dispensing system of claim 7, wherein the compliant members each comprise a partial sleeve configured to fit over a respective one of the rigid sub structures.

10. The storage and dispensing system of claim 6, wherein the compliant members are overmolded onto the rigid sub structures.

11. The storage and dispensing system of claim 7, wherein the compliant members are overmolded onto the rigid sub structures.

12. The storage and dispensing system of claim 1, wherein the inner film and the outer film are laminated together.

13. The storage and dispensing system of claim 1, further comprising at least one fitting, wherein the at least one exit passage is configured to receive the at least one fitting and places the at least one fitting in fluid communication with the bag interior.

14. The storage and dispensing system of claim 13, wherein the at least one fitting is a hose barb, a luer fitting, a quick connect fitting, or a flare-type fitting.

15. The storage and dispensing system of claim 1, further comprising at least one tubing stub and at least one annular film depending from the at least one tubing stub, wherein the at least one exit passage is configured to receive the at least one tubing stub and places the at least one tubing stub and annular film in fluid communication with the bag interior.

16-21. (canceled)

22. The storage and dispensing system of claim 1, wherein the single use bag has a volume of about 500 mL, about 1 L about 2 L, about 5 L, about 10 L, or about 20 L.
